(19) United States
(12) Patent Application Publication
(10) Pub. No.: US 2020/0056772 A1
(43) Pub. Date: Feb. 20, 2020

(54) Modular Circuit, LED Lamp and Modular Luminaire

(71) Applicant: HUNAN YUEGANG MOOKRAY INDUSTRIAL CO., LTD., Changde (CN)

(72) Inventor: Heng ZHU, ShenZhen (CN)

(73) Assignee: HUNAN YUEGANG MOOKRAY INDUSTRIAL CO., LTD., Changde (CN)

(21) Appl. No.: 16/607,725

(22) PCT Filed: May 19, 2017
(86) PCT No.: PCT/CN2017/085220

§ 371 Date: Oct. 24, 2019

(30) Foreign Application Priority Data
Apr. 25, 2017 (CN) 201710279342.5

(51) Int. Cl. F21V 23/06; H01R 29/00; F21V 19/00; F21V 29/503; F21V 7/05; F21V 13/14; F21V 7/26; F21V 29/70; F21V 17/12; F21V 23/02

(52) U.S. Cl. CPC F21V 23/06; H01R 29/00; F21V 19/003; F21V 29/503; F21V 19/0025; F21Y 2115/10; F21V 13/14; F21V 7/26; F21V 29/70; F21V 17/12; F21V 23/02; F21V 7/05

(57) ABSTRACT

A modular circuit includes a female plug-in module and a female plug-in connector connected to the female plug-in module. The female plug-in module includes an N-hedron. A plurality of first sockets or first pins are provided on each surface of the N-hedron. The first sockets or first pins on different surfaces are electrically connected in series or in parallel to form a plurality of circuits connected in series or in parallel on the N-hedron. N is greater than or equal to 2. The female plug-in connector includes a connector body, and second sockets or second pins are respectively provided at two ends of the connector body. The second sockets or second pins at the two ends of the connector body are electrically connected in series or in parallel.

### CROSS REFERENCE TO THE RELATED APPLICATIONS

This application is the national phase entry of International Application No. PCT/CN 2017/085220, filed on May 19, 2017, which is based upon and claims priority to Chinese Patent Application No. 201710279342.5, filed on Apr. 25, 2017, the entire contents of which are incorporated herein by reference.

### TECHNICAL FIELD

The present disclosure relates to the field of illumination technology, and particularly to a modular circuit, a light-emitting diode (LED) lamp and a modular luminaire.

### BACKGROUND

Throughout the 20-year history of development in the LED industry, the circuits of all LED products are connected through printed circuit boards (PCB), flexible copper clad circuit boards (FCC), along with wires and plugs. The voltage, current and data transmission are controlled by the layout design of the circuit board. Specifically, the LED is soldered on the circuit board. The connectors are only used for current and data conduction between the wires and the boards, which are dependent on the existence of the circuit boards and the wires, and cannot be independently used as circuit control devices.

In addition, over the past 20 years of the development in the LED industry, all products fail to be connected without circuit boards, wires and connectors. This circuit connection mode is the basic mode for the design of all electronic and electrical products, and is a traditional process mode that is used for large-scale production through a fully automated soldering process with a PCB board as the carrying platform.

However, as for lighting products, as well as many personalized and customized products in other industries, this circuit design method has many deficiencies. For example, as far as the cost control is concerned, the manufacturing of the products is required to be at a certain scale to facilitate production by the PCB soldering process, which is not suitable for small batches and different kinds of customized production. As far as heat conduction is concerned, the insulation layer of the circuit board has a large thermal resistance, which is not conducive for the purpose of heat dissipation. As far as the shape and structure of the PCB are concerned, the hard PCB cannot be bent arbitrarily, nor can the flexible board be shaped arbitrarily. As far as the waterproof performance is concerned, a secondary peripheral sealing process is required. These problems have brought up many adverse effects on the development, design, manufacturing, installation, use and maintenance of lighting products, thereby hindering the active development of the PCB and LED products industry.

### SUMMARY

In view of the deficiencies of the prior art, the present disclosure provides a modular circuit, an LED lamp, and a modular luminaire.

The specific technical solution of a modular circuit of the present disclosure is as follows:

A modular circuit includes a female plug-in module and a female plug-in connector connected to the female plug-in module. The female plug-in module includes an N-sided polyhedron (“N-hedron”). A plurality of first sockets or first pins are provided on each surface of the N-hedron to form a plurality of positive and negative junctions. The first sockets or first pins on different surfaces are electrically connected in series or in parallel to form a plurality of circuits connected in series or in parallel the N-hedron; wherein N is greater than or equal to 2. The female plug-in connector includes a connector body, and second sockets or second pins are respectively provided at two ends of the connector body. The second sockets or the second pins at the two ends of the connector body are electrically connected in series or in parallel to form a plurality of circuits connected in series or in parallel on the connector body. A plurality of the female plug-in connectors and a plurality of the female plug-in modules are combined and connected in different manners to form a series circuit, a parallel circuit and/or a series-parallel circuit.

In the modular circuit of the present disclosure, the plurality of female plug-in connectors and the plurality of female plug-in modules are combined and connected in different manners to form the series circuit, the parallel and/or the series-parallel circuit. Therefore, the traditional circuit design mode is superseded, and the wires, circuit boards and connectors are integrated thoroughly, which can achieve the functions of the original PCB circuit design mode, and meanwhile can effectively solve various problems of the prior art. Moreover, the cost is reduced, and the lighting products are further standardized and diversified. On the supply-side advances, the green manufacturing and use are realized, which promotes the industry development, and guides the green consumption.

According to a preferred embodiment, the connector body has a flat shape. A female plug-in connector is formed by the flat connector body and the second sockets or second pins respectively provided at the two ends of the flat connector body and electrically connected in series or in parallel.

According to a preferred embodiment, the connector body has an elongated shape, and the connector body includes a plastic layer and a flexible metal wrapped by the plastic layer, so that the elongated connector body can be bent and shaped arbitrarily.

According to a preferred embodiment, the connector body has M kinds of lengths; wherein M is greater than or equal to 1.

According to a preferred embodiment, the modular circuit further includes a power module. The power module is a plug-type power module, and is plugged into and connected to the female plug-in connector or the female plug-in module.

The specific technical solution of an LED lamp of the present disclosure is as follows:

An LED lamp includes the female plug-in module as described above, a plurality of plug-type LED light sources, a lamp cap and a plug-type power module. The plug-type power module is provided inside the lamp cap, and a pin on the plug-type power module passes through the lamp cap and is connected to the female plug-in module. The plurality of a plug-type LED light sources are plugged into and connected to the female plug-in module as needed to enable the LED lamp to form into the desired shape.

In the LED lamp of the present disclosure, a female plug-in module, is configured to enable the plurality of plug-type LED light sources to be plugged into and connected to the female plug-in module as needed, so that the LED lamp can be formed into the desired shape. In the present disclosure, various forms of luminaires can be combined through the female plug-in module and the female plug-in connector without the need for a PCB. Compared with the traditional luminaires, the soldering process is eliminated, and the heat dissipation of the light source is not interfered with. Therefore, the products are relatively simple, convenient, and inexpensive.

The specific technical solution of a modular luminaire of the present disclosure is as follows:

A modular luminaire includes the modular circuit as described above and a plug-type LED light source provided on the modular circuit. The plurality of female plug-in connectors and the plurality of female plug-in modules in the modular circuit are combined and connected in different manners to enable the modular luminaire form into different shapes.

According to a preferred embodiment, the plug-type LED light source includes a heat sink. A heat-dissipation structure is formed at the lower portion of the heat sink; a cup cavity is provided at the middle portion of a top end of the heat sink; and a first thread is provided at the edge of a top end of the heat sink. Positive and negative electrodes are provided in the cup cavity, and the LED chip is then mounted in the cup cavity and connected to the positive and negative electrodes. A mirror is provided above the cup cavity, and the mirror is integratedly connected to a metal sheet by the injection molding process, and then is screwed onto the cup cavity. A lens is provided above the metal sheet, and the lens is integratedly fixed to a metal component by the injection molding process or by the insertion manner. A second thread and a gasket are provided at the bottom of the metal component, and the metal component is coupled to the heat sink via the second thread and the first thread. A male plug or female socket, which passes through the heat sink, and the heat-dissipation structure, and is connected to the positive and negative pins of the positive and negative electrodes, is formed on the heat sink; and the male plug or female socket protrudes from the heat-dissipation structure, so as to facilitate the plug-type connection between the plug-type LED light source and the modular circuit.

According to a preferred embodiment, the mirror is a flat mirror or a curved mirror and is doped with phosphor.

According to a preferred embodiment, a light reflecting structure is formed at a junction of the lens and the metal component.

According to a preferred embodiment, the heat-dissipation structure includes a heat-dissipation column, a heat-dissipation wing or a heat-dissipation fan.

In the modular luminaire of the present disclosure, the modular luminaires can be formed into different shapes by combining and connecting the plurality of female plug-in connectors with the plurality of female plug-in modules in different manners in the modular circuit, thereby greatly improving the adaptability of the components of the luminaire, and realizing a universal, optional, and replaceable modular luminaire. Moreover, in the present disclosure, various forms of luminaires can be combined through the female plug-in module and the female plug-in connector without the need for a PCB. Compared with the traditional luminaires, the soldering process is eliminated, and the heat dissipation of the light source is not interfered with; and the products are relatively simple, handy, and inexpensive.

Compared with the prior art, the present disclosure has the following advantages:

In the modular circuit of the present disclosure, the plurality of female plug-in connectors and the plurality of female plug-in modules are combined and connected in different manners to form the series, parallel and/or series-parallel circuits. Therefore, the traditional circuit design mode is abandoned, and the wires, circuit boards and connectors are completely integrated to achieve the functions of the original PCB circuit design mode. Meanwhile, various problems in the prior art are effectively solved, the cost is reduced, and the lighting products are further standardized and diversified. On the supply-side advances, the green manufacturing and use are realized, the industry development is promoted, and the green consumption is guided.

In the LED lamp of the present disclosure, a female plug-in module is configured to enable a plurality of plug-type LED light sources to be plugged into and connected to the female plug-in module as needed, so that the LED lamp can be formed into the desired shape. In the present disclosure, various forms of luminaires can be combined through the female plug-in module and the female plug-in connector without the need for a PCB. Compared with the traditional luminaires, the soldering process is eliminated, and the heat dissipation of the light source is not interfered with; and the products are relatively simple, handy, and inexpensive.

In the modular luminaire of the present disclosure, modular luminaires can be formed into different shapes by combining and connecting the plurality of the female plug-in connectors with the plurality of the female plug-in modules in different manners in the modular circuit, thereby greatly improving the adaptability of the components of the luminaire, and realizing a universal, optional, and replaceable modular luminaire. Moreover, in the present disclosure, various forms of luminaires can be combined through the female plug-in module and the female plug-in connector without the need for a PCB. Compared with the traditional luminaires, the soldering process is eliminated, the heat dissipation of the light source is not interfered with; and the products are relatively simple, handy, and inexpensive.

### BRIEF DESCRIPTION OF THE DRAWINGS

FIGS. 1 to 5 are structural schematic diagrams of the different female plug-in modules in a modular circuit of the present disclosure;

FIG. 6 is a schematic diagram showing a connection of a female plug-in module and a light source module in the modular circuit of the present disclosure;

FIG. 7 is a structural schematic diagram of a first type of a female plug-in connector in the modular circuit of the present disclosure;

FIG. 8 is a structural schematic diagram of a second type of a female plug-in connector in the modular circuit of the present disclosure;

FIG. 9 is a structural schematic diagram of a third type of a female plug-in connector in the modular circuit of the present disclosure;

FIG. 10 is a structural schematic diagram of a fourth type of a female plug-in connector in the modular circuit of the present disclosure;

FIG. 11 is a structural schematic diagram of a fifth type of a female plug-in connector in the modular circuit of the present disclosure;

FIG. 12 is a schematic diagram showing a connection of a female plug-in module and a fifth type of female plug-in connector in the modular circuit of the present disclosure;

FIG. 13 is a circuit schematic diagram showing a triple-pathway and triple-series connection mode formed by combining the female plug-in module and the female plug-in connector in the modular circuit of the present disclosure;

FIG. 14 is a circuit schematic diagram showing a triple-series and triple-parallel connection mode formed by combining the female plug-in module and the female plug-in connector in the modular circuit of the present disclosure;

FIG. 15 is a structural schematic diagram of an LED lamp of the present disclosure;

FIG. 16 is an exploded view of the LED lamp of the present disclosure;

FIG. 17 is a schematic diagram showing a preferred structure of a modular luminaire of the present disclosure;

FIG. 18 is a schematic diagram showing a second preferred structure of the modular luminaire of the present disclosure;

FIG. 19 is a schematic diagram showing a connection between the female plug-in module and the light source module in FIG. 18;

FIG. 20 is a schematic diagram showing a connection between the female plug-in modules having the light source in FIG. 18;

FIG. 21 is a schematic diagram showing a third preferred structure of the modular luminaire of the present disclosure;

FIG. 22 is a schematic diagram showing a connection between one female plug-in module and another female plug-in module having the light source in FIG. 21;

FIG. 23 is a schematic diagram showing a fourth preferred structure of the modular luminaire of the present disclosure;

FIG. 24 is a schematic diagram showing a fifth preferred structure of the modular luminaire of the present disclosure;

FIG. 25 is a structural schematic diagram of a plug-type power module;

FIG. 26 is an enlarged view of a cup cavity in the plug-type power module; and

FIG. 27 is a structural schematic diagram of a lower portion of a heat sink in the plug-type power module.

### DETAILED DESCRIPTION OF THE EMBODIMENTS

The present disclosure will be described in detail below with reference to the drawings.

### Embodiment 1

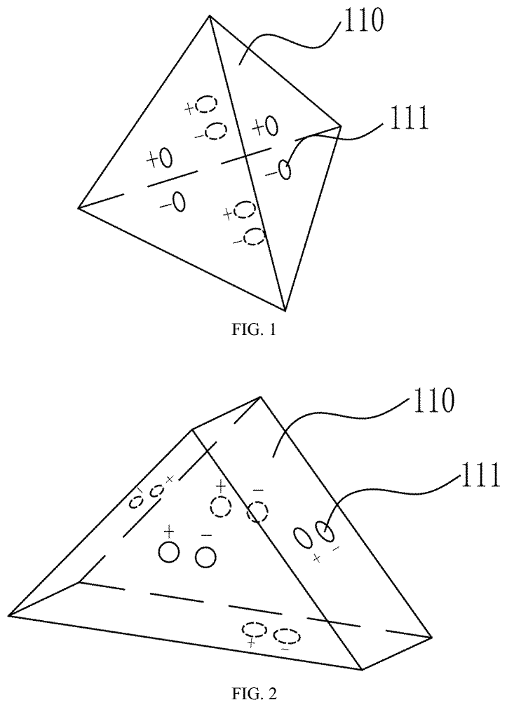

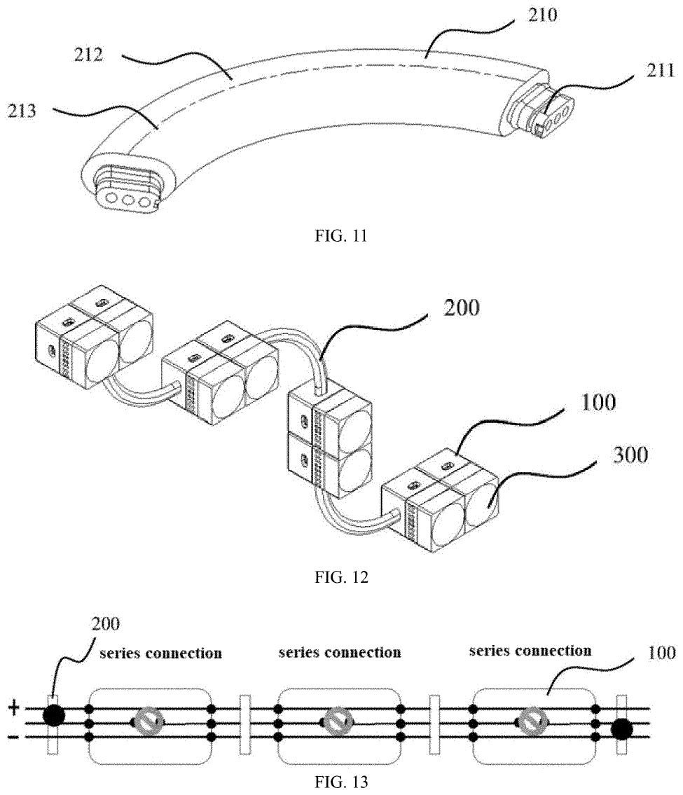

As shown in FIGS. 1-14, the modular circuit includes the female plug-in module 100 and the female plug-in connector 200 connected to the female plug-in module 100.

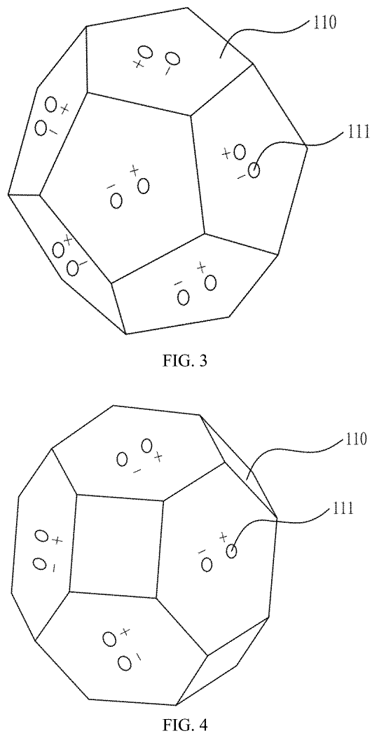

The female plug-in module 100 includes the N-hedron 110, wherein N is greater than or equal to 2. The female plug-in module 100 may be a tetrahedron as shown in FIG. 1, a pentahedron as shown in FIG. 2, a 12-hedron as shown in FIG. 3, a 10-hedron as shown in FIG. 4, or an irregular polyhedron as shown in FIG. 5.

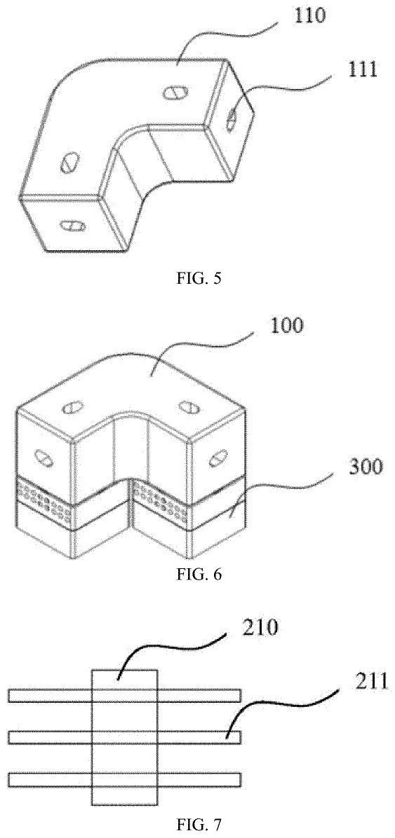

The plurality of the first sockets or the first pins 111 are provided on each surface of the N-hedron 110 to form a plurality of positive and negative junctions. The first socket or the first pin 111 on different surfaces, are electrically connected in series or in parallel such that a plurality of circuits connected in series or in parallel are formed on the N-hedron 110. The LED light source 300 can be plugged into the female plug-in module 100 as shown in FIG. 6.

The female plug-in connector 200 includes the connector body 210, and the second sockets or second pins 211 are respectively provided at two ends of the connector body 210. The second sockets or second pins 211 at the two ends of the connector body 210 are electrically connected in series or in parallel, so that a plurality of circuits connected in series or in parallel are formed on the connector body 210.

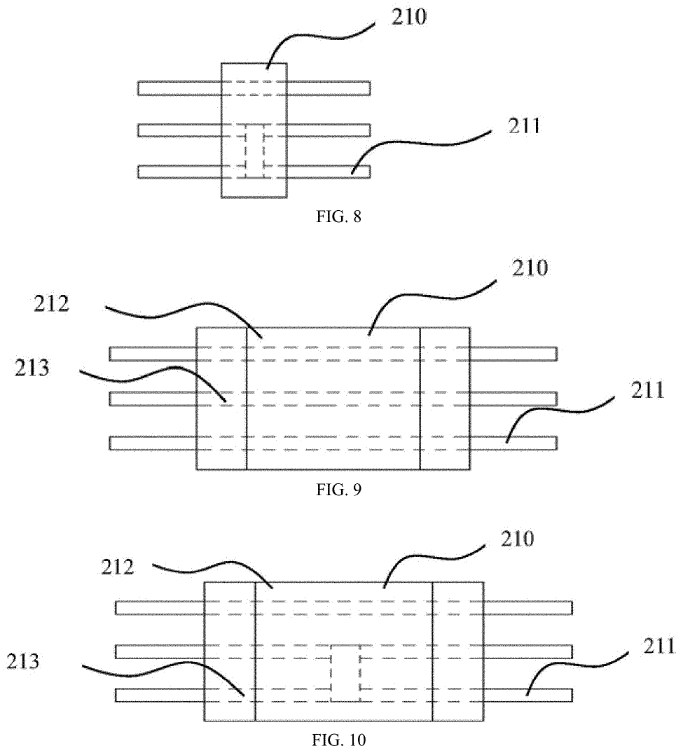

Preferably, as shown in FIGS. 7 and 8, the connector body 210 is flat. The female plug-in connector 200 is formed by the flat connector body 210 and the second sockets or second pins 211 respectively provided at the two ends of the flat connector body 210 and electrically connected in series or in parallel.

Preferably, as shown in FIGS. 9 and 10, the connector body 210 is elongated. Moreover, the connector body 210 includes the plastic layer 212 and the flexible metal 213 wrapped by the plastic layer, so that the elongated connector body 210 can be bent and shaped arbitrarily. The connector body 210 is designed to combine the flexible metal with the plastic layer structure, which can not only bend arbitrarily, but also bear a certain weight. The connector body 210 has M kinds of lengths, wherein M is greater than or equal to 1. The connector body 210 of different lengths is configured to satisfy different practical needs in the actual connection.

As shown in FIGS. 12-14, the plurality of the female plug-in connectors 200 and the plurality of the female plug-in modules 100 are combined and connected in different manners, so as to form the series, parallel and/or series-parallel circuits.

Specifically, the second sockets or the second pins 211 on the connector body 210 of the plurality of female plug-in connectors 200 are connected to the first sockets or first pins 111 on different surfaces of the N-hedron 110 of the plurality of female plug-in modules 100, thereby forming the series, parallel and/or series-parallel circuits.

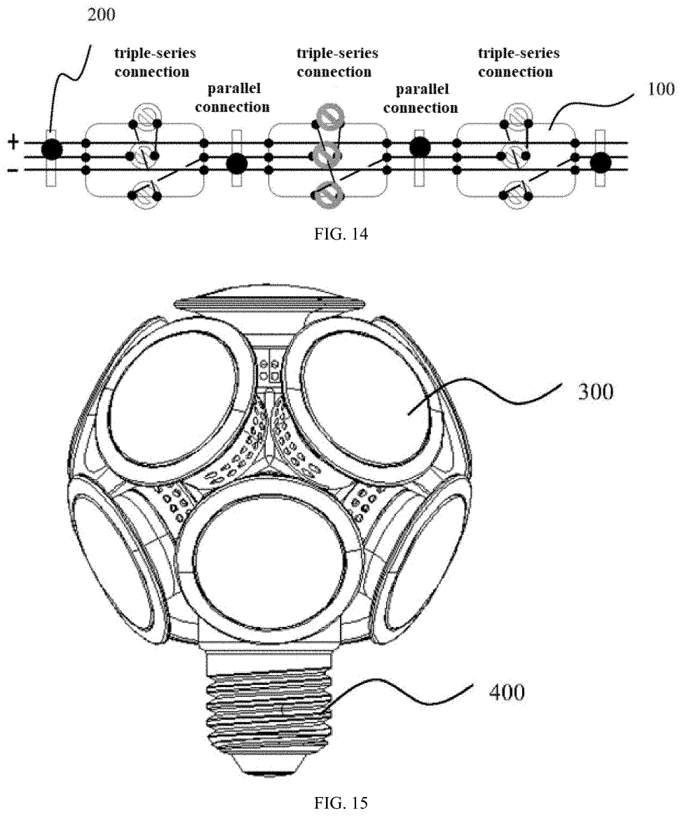

For example, a triple-pathway and triple-series connection circuit, as shown in FIG. 13, may be formed, or a triple-series and triple-parallel connection circuit as shown in FIG. 14 may be formed; where [symbol] represents a positive-negative light source [symbol] represents a negative-positive light source; and ● indicates that the two wires are conducting current.

Further, the modular circuit of the present embodiment may include a power module (not shown in the drawings). Preferably, the power module is a plug-type power module, and is connected to the female plug-in connector 200 or the female plug-in module 100 in a plug-in manner.

In the modular circuit of the present embodiment, the plurality of female plug-in connectors and the plurality of female plug-in modules are combined and connected in different manners to form the series, parallel and/or series-parallel circuits. Therefore, the traditional circuit design mode is abandoned, and the wires, circuit boards and connectors are completely integrated to achieve the functions of the original PCB circuit design mode. Meanwhile, various problems in the prior art are effectively solved, the cost is reduced, and the lighting products are further standardized and diversified. Through the supply-side development, the green manufacturing and use are realized, the industry development is promoted, and the green consumption is guided.

### Embodiment 2

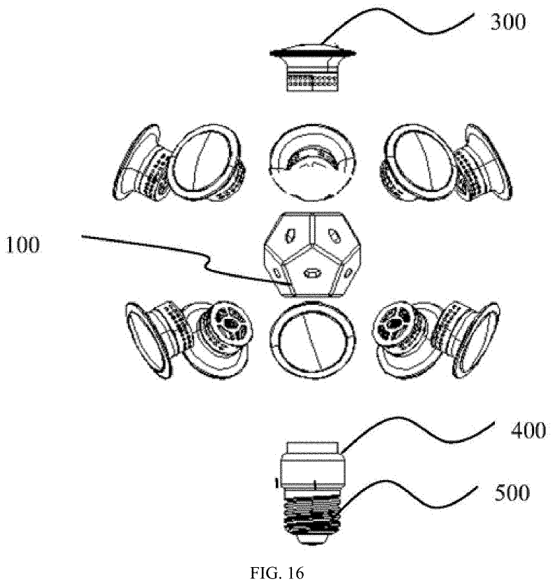

As shown in FIGS. 15 and 16, the LED lamp includes the female plug-in module 100, the plurality of plug-type LED light sources 300, the lamp cap 400 and the plug-type power module 500.

The plug-type power module 500 is provided inside the lamp cap 400, and the pin 510 on the plug-type power module 500 passes through the lamp cap 400 and is connected to the female plug-in module 100.

The plurality of plug-type LED light source 300 is plugged into the female plug-in module 100 as needed to enable the LED lamp to form into the desired shape.

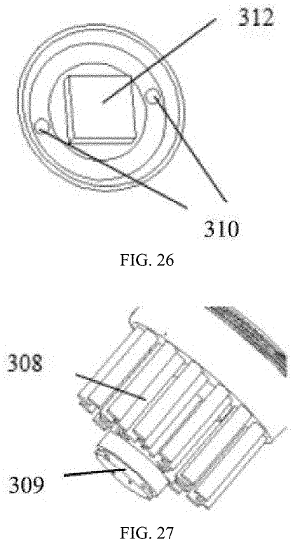

The plug-type power module 500 is shown in FIG. 25, FIG. 26, and FIG. 27, including the heat sink 301. A heat-dissipation structure is formed at a lower portion of the heat sink 301, the cup cavity 302 is provided at a middle portion of a top end of the heat sink 301, and the first thread 311 is provided at an edge of a top end of the heat sink 301.

The positive and negative electrodes 310 are provided in the cup cavity 302, and the LED chip 312 is mounted in the cup cavity 302 and is connected to the positive and negative electrodes 310.

The mirror 304 is provided above the cup cavity 302, and the mirror 304 is integratedly connected to the metal sheet 305 by the injection molding process, and then is screwed onto the cup cavity 302.

The lens 306 is provided above the metal sheet 305, and the lens 306 is integratedly fixed to the metal component 307 by the injection molding process or in the insertion manner. A light reflecting structure is formed at a junction of the lens 306 and the metal component 307. A second thread and a gasket are provided at the bottom of the metal component 307, and the metal component 307 is coupled to the heat sink 301 via the second thread and the first thread 311.

The male plug or female socket 309, which passes through the heat sink 301 and a heat-dissipation structure and is connected to the positive and negative pins 303 of the positive and negative electrodes 310, is formed on the heat sink 301; and the male plug or female socket 309 protrudes from the heat-dissipation structure, so as to facilitate the plug-type connection between the plug-type LED light source 300 and the modular circuit.

Preferably, the mirror 304 is a flat mirror or a curved mirror and is doped with phosphor. A light reflecting structure is formed at a junction of the lens 306 and the metal component 307. The heat-dissipation structure includes a heat-dissipation column, a heat-dissipation wing or a heat-dissipation fin (the figures show the heat-dissipation column 308).

In the LED lamp of the present disclosure, a female plug-in module, is configured to enable a plurality of plug-type LED light sources to be plugged into the female plug-in module as needed so that the LED lamp can be formed into the desired shape. In the present disclosure, various forms of luminaires can be combined through the female plug-in module and the female plug-in connector without the need for a PCB. Compared with the traditional luminaires, the soldering process is eliminated, and the heat dissipation of the light source is not interfered with; and the products are relatively simple, handy, and inexpensive.

### Embodiment 3

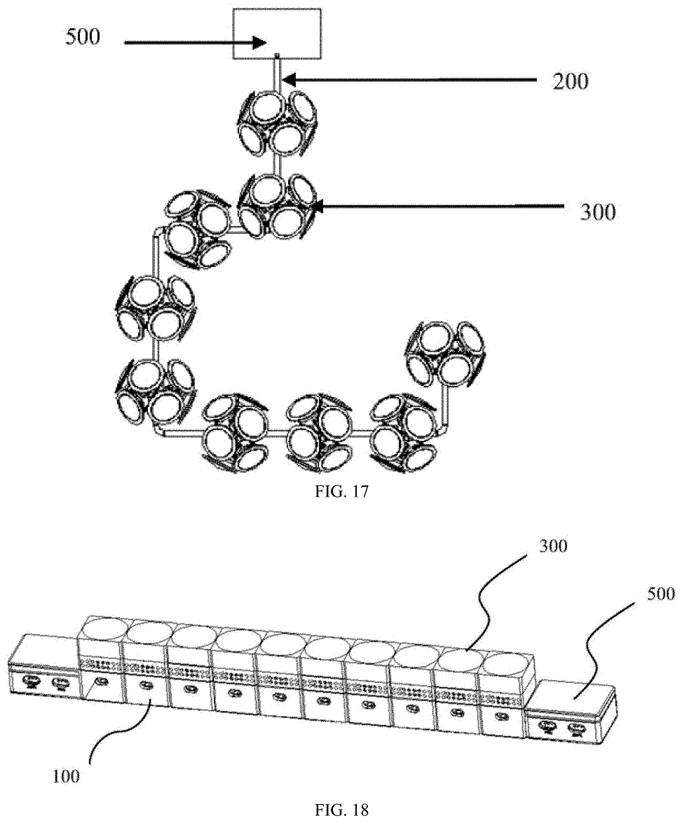

As shown in FIGS. 17-25, the present embodiment provides a modular luminaire including a modular circuit and the plug-type LED light source 300 provided on the modular circuit.

The modular luminaire can be formed into different shapes by combining and connecting the plurality of female plug-in connectors 200 with the plurality of female plug-in modules 100 in different manners in the modular circuit.

For example, the plug-type LED light source 300, the female plug-in module 100 and the female plug-in connector 200, capable of arbitrarily bending, can be combined to form the modular luminaire as shown in FIG. 17. The modular luminaire is then connected to the power module 500 to form a completed luminaire.

For example, the female plug-in module 100, the flat female plug-in connector 200, and the plug-type LED light source 300 can also be combined to form a planar modular luminaire as shown in FIG. 18. The modular luminaire is then connected to the power module 500 to form a completed luminaire.

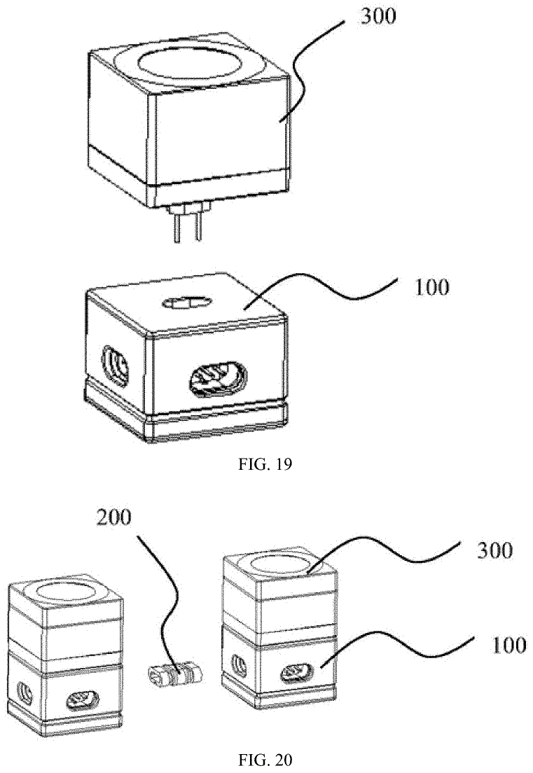

In FIG. 18, the female plug-in module 100 is connected to the plug-type LED light source 300 in a plug-in manner, specifically as shown in FIG. 19. The female plug-in modules 100 having the plug-type LED light source 300 are then connected to each other by the female plug-in connector 200 (as shown in FIG. 20) to form the planar modular luminaire as shown in FIG. 18.

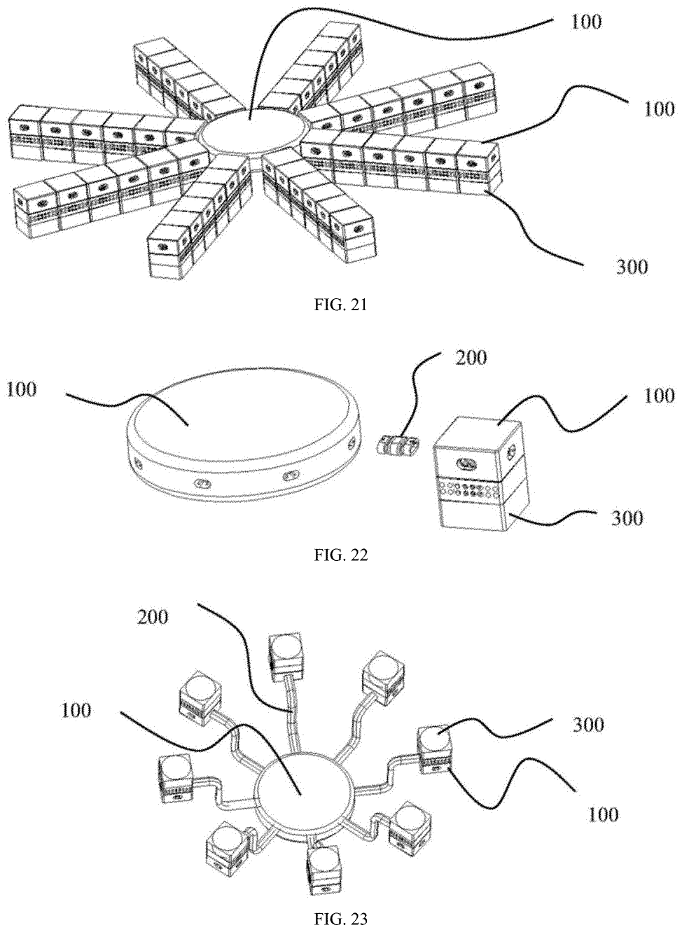

For example, the female plug-in module 100, the flat female plug-in connector 200, and the plug-type LED light source 300 can also be combined to form an eight pointed star-shaped modular luminaire as shown in FIG. 21. The modular luminaire is then connected to the power module 500 to form a completed luminaire.

As shown in FIG. 21, the female plug-in module 100 is connected to the plug-type LED light source 300 in a plug-in manner to form the female plug-in module 100 having the plug-in LED light source 300. The plurality of female plug-in modules 100 having the plug-type LED light sources 300 are connected to another cylindrical-shaped female plug-in module via the female plug-in connector 200, as shown in FIG. 22, thereby forming the eight pointed star-shaped modular luminaire as shown in FIG. 22.

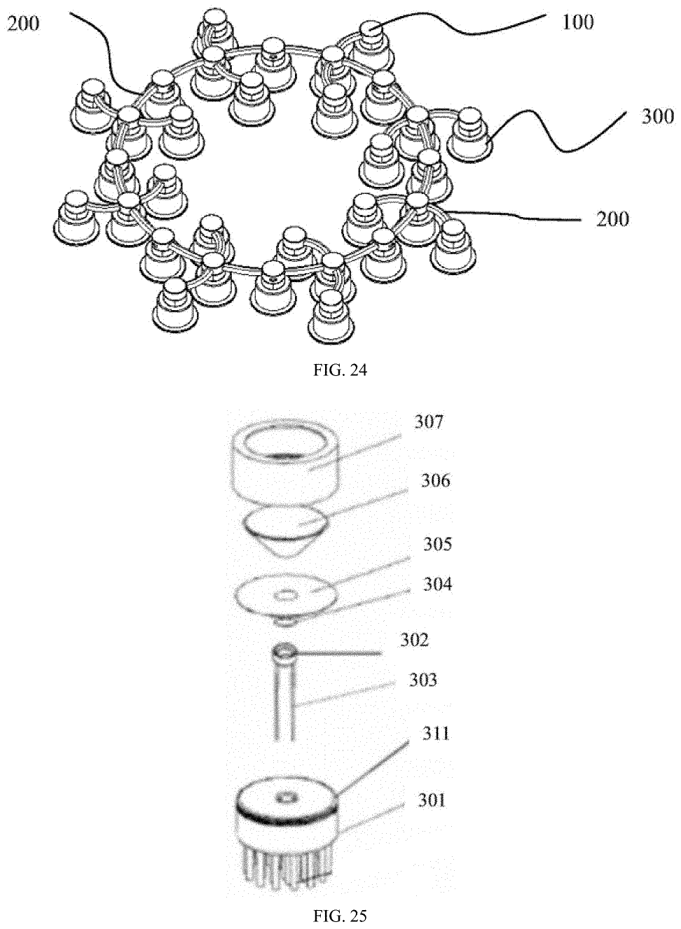

Besides, in the present embodiment, the female plug-in module 100, the flat female plug-in connector 200, and/or the female plug-in connector 200, capable of arbitrarily bending, and the plug-type LED light source 300 can also constitute the modular luminaire as shown in FIGS. 23 and 24, respectively.

As shown in FIGS. 25, 26 and 27, the plug-type LED light source includes the heat sink 301. A heat-dissipation structure is formed at a lower portion of the heat sink 301, the cup cavity 302 is provided at the middle portion of the top end of the heat sink 301, and the first thread 311 is provided at an edge of a top end of the heat sink 301.

The positive and negative electrodes 310 are provided in the cup cavity 302, and the LED chip 312 is mounted in the cup cavity 302 and is connected to the positive and negative electrodes 310.

The mirror 304 is provided above the cup cavity 302, and the mirror 304 is integratedly connected to the metal sheet 305 by the injection molding process, and then screwed onto the cup cavity 302.

The lens 306 is provided above the metal sheet 305, and the lens 306 is integratedly fixed to the metal component 307 by the injection molding process or in the insertion manner. A second thread and a gasket are provided at the bottom of the metal component 307, and the metal component 307 is coupled to the heat sink 301 via the second thread and the first thread 311.

The male plug or female socket 309, which passes through the heat sink 301 and the heat-dissipation structure and is connected to the positive and negative pins 303 of the positive and negative electrodes 310, is formed on the heat sink 301. The male plug or female socket 309 protrudes from the heat-dissipation structure, so as to facilitate the plug-type connection between the plug-type LED light source 300 and the modular circuit.

Preferably, the mirror 304 is a flat mirror or a curved mirror, and is doped with the phosphor. A light reflecting structure is formed at a junction of the lens 306 and the metal component 307. The heat-dissipation structure includes the heat-dissipation column 308, a heat-dissipation wing or a heat-dissipation fin (the figures show the heat-dissipation column 308).

In the modular luminaire of the present disclosure, the modular luminaires can be formed into different shapes by combining and connecting the plurality of female plug-in connectors with the plurality of female plug-in modules in different manners in the modular circuit, thereby greatly improving the adaptability of the components of the luminaire, and realizing a universal, optional, and replaceable modular luminaire. Moreover, in the present disclosure, various forms of luminaires can be combined through the female plug-in module and the female plug-in connector without the need for a PCB. Compared with the traditional luminaires, the soldering process is eliminated, the heat dissipation of the light source is not interfered with; and the products are relatively simple, handy, and inexpensive.

It should be noted that all features disclosed in the specification, or the steps of all methods or processes disclosed, may be combined in any manner other than mutually exclusive features and/or steps.

In addition, the above specific embodiments are exemplary, and those skilled in the art can devise various solutions inspired by the present disclosure. These solutions also belong to the disclosed scope of the present disclosure and fall within the protective scope of the present disclosure. It should be understood by those skilled in the art that the specification and the drawings of the present disclosure are illustrative rather than constitute a limitation on claims. The protective scope of the present disclosure is defined by the claims and their equivalents.

What is claimed is:

1. A modular circuit, comprising: a female plug-in module and a female plug-in connector connected to the female plug-in module;
wherein, the female plug-in module comprises an N-hedron; a plurality of first sockets or first pins are provided on each surface of the N-hedron to form a plurality of positive and negative junctions; the plurality of first sockets or first pins on different surfaces are electrically connected in series or in parallel to form a plurality of first circuits connected in series or in parallel on the N-hedron; wherein N is greater than or equal to 2;
the female plug-in connector comprises a connector body, and second sockets or second pins are respectively provided at two ends of the connector body;
the second sockets or second pins at the two ends of the connector body are electrically connected in series or in parallel to form a plurality of second circuits connected in series or in parallel on the connector body; and
a plurality of the female plug-in connectors and a plurality of the female plug-in modules are combined and connected in different manners to form a series circuit, a parallel circuit and/or a series-parallel circuit.

2. The modular circuit according to claim 1, wherein, the connector body has a flat shape; the female plug-in connector is formed by the connector body and the second sockets or second pins.

3. The modular circuit according to claim 1, wherein, the connector body has an elongated shape; and
the connector body comprises a plastic layer and a flexible metal wrapped by the plastic layer, and the connector body is bent and shaped arbitrarily.

4. The modular circuit according to claim 3, wherein, a plurality of connector bodies has M kinds of lengths; wherein M is greater than or equal to 1.

5. The modular circuit according to claim 1, further comprising a power module;
wherein, the power module is a plug-type power module and is connected to the female plug-in connector or the female plug-in module in a plug-in manner.

6. An LED lamp, characterized in that, comprising the female plug-in module according to claim 1, a plurality of plug-type LED light sources, a lamp cap and a plug-type power module;
wherein, the plug-type power module is provided inside the lamp cap, and a pin on the plug-type power module passes through the lamp cap and is connected to the female plug-in module; and
the plurality of plug-type LED light sources are plugged into and connected to the female plug-in module to enable the LED lamp to form into a desired shape.

7. A modular luminaire, comprising the modular circuit according to claim 1, and a plug-type LED light source provided on the modular circuit;
wherein, the plurality of female plug-in connectors and the plurality of female plug-in modules are combined and connected in different manners in the modular circuit to enable the modular luminaire to form into different shapes.

8. The modular luminaire according to claim 7, wherein, the plug-type LED light source comprises a heat sink;
a heat-dissipation structure is formed at a lower portion of the heat sink, a cup cavity is provided at a middle portion of a top end of the heat sink, and a first thread is provided at an edge of the top end of the heat sink;
positive and negative electrodes are provided in the cup cavity, and an LED chip is mounted in the cup cavity and is connected to the positive and negative electrodes;
a mirror is provided above the cup cavity, and the mirror is integratedly connected to a metal sheet by an injection molding process, and is screwed onto the cup cavity;
a lens is provided above the metal sheet, and the lens is integratedly fixed to a metal component by the injection molding process or in an insertion manner; a second thread and a gasket are provided at a bottom of the metal component, and the metal component is coupled to the heat sink via the second thread and the first thread; and
a male plug or female socket passes through the heat sink and the heat-dissipation structure and is connected to positive and negative pins of the positive and negative electrodes; the male plug or female socket is formed on the heat sink and protrudes from the heat-dissipation structure.

9. The modular luminaire according to claim 8, wherein, the mirror is a flat mirror or a curved mirror and is doped with phosphor; a light reflecting structure is formed at a junction of the lens and the metal component.

10. The modular luminaire according to claim 8, wherein, the heat-dissipation structure comprises a heat-dissipation column, a heat-dissipation wing and a heat-dissipation fin.

11. The LED lamp according to claim 6, wherein, the connector body has a flat shape; the female plug-in connector is formed by the connector body and the second sockets or second pins.

12. The LED lamp according to claim 6, wherein, the connector body has an elongated shape; and
the connector body comprises a plastic layer and a flexible metal wrapped by the plastic layer, and the connector body is bent and shaped arbitrarily.

13. The LED lamp t according to claim 12, wherein, a plurality of connector bodies has M kinds of lengths; wherein M is greater than or equal to 1.

14. The LED lamp according to claim 6, further comprising a power module;
wherein, the power module is a plug-type power module and is connected to the female plug-in connector or the female plug-in module in a plug-in manner.

15. The modular luminaire according to claim 7, wherein, the connector body has a flat shape; the female plug-in connector is formed by the connector body and the second sockets or second pins.

16. The modular luminaire according to claim 7, wherein, the connector body has an elongated shape; and
the connector body comprises a plastic layer and a flexible metal wrapped by the plastic layer, and the connector body is bent and shaped arbitrarily.

17. The modular luminaire according to claim 16, wherein, the connector body has M kinds of lengths; wherein M is greater than or equal to 1.

18. The modular luminaire according to claim 7, further comprising a power module;
wherein, the power module is a plug-type power module and is connected to the female plug-in connector or the female plug-in module in a plug-in manner.
